(19) United States
(12) Patent Application Publication
(10) Pub. No.: US 2026/0149618 A1
(43) Pub. Date: May 28, 2026

(54) FAST-CONVERGENCE FOR SELECTIVE MULTICAST TRAFFIC WITH ALL-ACTIVE MULTIHOMING

(71) Applicant: Cisco Technology, Inc., San Jose, CA (US)

(72) Inventors: Mankamana Prasad Mishra, San Jose, CA (US); Ali Sajassi, San Ramon, CA (US); Luc André Burdet, Gatineau (CA); Sameer R. Gulrajani, Fremont, CA (US); Vishakha Mysore Vedavyas, Milpitas, CA (US)

(21) Appl. No.: 18/961,634

(22) Filed: Nov. 27, 2024

(51) Int. Cl. H04L 12/18; H04L 12/46; H04L 45/16

(52) U.S. Cl. CPC H04L 12/1886; H04L 12/4641; H04L 45/16

(57) ABSTRACT

A method performed by a provider edge node of an Ethernet virtual private network (EVPN) in which the provider edge node is configured to communicate with peer provider edge nodes of the EVPN that are multihomed to a multicast receiver, comprises: receiving, from the peer provider edge nodes, selective multicast routes for multicast traffic, and designated forwarder states that each indicates whether a respective one of the peer provider edge nodes is a designated forwarder or a non-designated forwarder for the multicast traffic; upon receiving the multicast traffic, determining which of the peer provider edge nodes is the designated forwarder for the multicast traffic based on the designated forwarder states received from the peer provider edge nodes; and selectively forwarding the multicast traffic only to the designated forwarder.

### TECHNICAL FIELD

The present disclosure relates to selective multicast forwarding in an Ethernet virtual private network (EVPN).

### BACKGROUND

An EVPN may include a source provider edge node connected to a multicast source that originates multicast traffic, and peer provider edge nodes that are multihomed to a multicast receiver on an Ethernet segment(ES). A provider edge node may be referred to simply as a “PE” and provider edge nodes may be referred to simply as “PEs. With “all-active multihoming,” all peer PEs are capable of forwarding the multicast traffic over the ES; however, the peer PEs elect a designated forwarder (DF) among themselves to serve as a sole forwarder of the multicast traffic over the ES. Each non-elected peer PE is a non-DF (NDF) that simply drops the multicast traffic. Upon receiving, from the multicast receiver, a join request for the multicast traffic, the peer PEs (i.e., the DF and each NDF alike) advertise respective selective multicast routes to the source PE, which imports the same. Then, upon receiving the multicast traffic from the multicast source, the source PE forwards the multicast traffic (also referred to as “selective” multicast traffic) to all (advertised) selective multicast routes (i.e., to all peer PEs) along separate paths. When the peer PEs receive the multicast traffic, only the DF forwards the multicast traffic to the multicast receiver, while each NDF simply drops the multicast traffic. Thus, forwarding the multicast traffic to each NDF in addition to the DF is unnecessary and wasteful.

When an ES failure forces the DF to advertise a withdrawal message indicating a withdrawal of the DF as a selective multicast route, the peer PEs elect an alternative DF and again advertise their selective multicast routes. The source PE again imports the readvertised selective multicast routes, and then reforwards the multicast traffic. The foregoing failure recovery process, referred to as “convergence of the selective multicast routes,” can introduce undesired delays and redundant forwarding of the multicast traffic through the EVPN.

### BRIEF DESCRIPTION OF THE DRAWINGS

FIG. 1 is a block diagram of an example EVPN in which embodiments directed to selective forwarding and fast-convergence for selective multicast traffic with all-active multihoming may be implemented, according to an example embodiment.

FIG. 2 shows transactions performed in the EVPN, by a source PE and peer PEs that are multihomed on an Ethernet segment, to implement the selective forwarding and fast-convergence for selective multicast traffic with all-active multihoming, according to an example embodiment.

FIG. 3 shows formats for selective multicast routes and a forwarding entry/table generated in connection with initial transactions shown in FIG. 2, according to an example embodiment.

FIG. 4 shows use of the forwarding entry by the source PE in connection with further transactions shown in FIG. 2, according to an example embodiment.

FIG. 5 shows a withdrawal message and use of the forwarding entry by the source PE in connection with further transactions shown in FIG. 2, according to an example embodiment.

FIG. 6 is a flowchart of a method of selectively forwarding, and implementing a fast-convergence, for selective multicast traffic that is performed by the source PE, according to an example embodiment.

FIG. 7 is a flowchart of a method performed by the peer PEs and the source PE, according to an example embodiment.

FIG. 8 illustrates a hardware block diagram of a computing device that may perform operations to implement the embodiments presented herein, according to an example embodiment.

### DESCRIPTION OF EXAMPLE EMBODIMENTS

### Overview

In an embodiment, a method is performed by a provider edge node of an Ethernet virtual private network (EVPN) in which the provider edge node is configured to communicate with peer provider edge nodes of the EVPN that are multihomed to a multicast receiver. The method comprises: receiving, from the peer provider edge nodes, selective multicast routes for multicast traffic, and designated forwarder states that each indicates whether a respective one of the peer provider edge nodes is a designated forwarder or a non-designated forwarder for the multicast traffic; upon receiving the multicast traffic, determining which of the peer provider edge nodes is the designated forwarder for the multicast traffic based on the designated forwarder states received from the peer provider edge nodes; and selectively forwarding the multicast traffic only to the designated forwarder.

In another embodiment, a method comprises: by peer provider edge nodes of an Ethernet virtual private network (EVPN) that are multihomed to a multicast receiver, advertising selective multicast routes for multicast traffic, and designated forwarder states that each indicates whether a respective one of the peer provider edge nodes is a designated forwarder or is a non-designated forwarder for the multicast traffic; and by a source provider edge node of the EVPN: receiving the selective multicast routes and the designated forwarder states from the peer provider edge nodes; upon receiving the multicast traffic from a multicast source, determining the designated forwarder of the peer provider edge nodes for the multicast traffic based on the designated forwarder states received from the peer provider edge nodes; and selectively forwarding the multicast traffic only to the designated forwarder.

### Example Embodiments

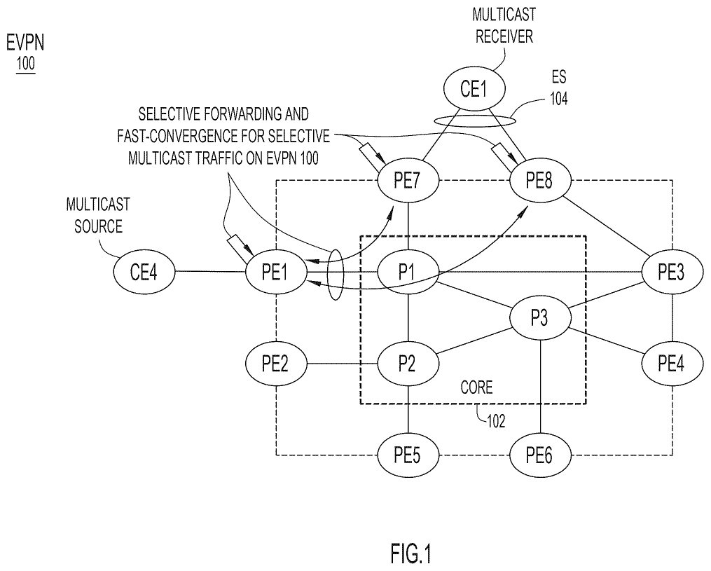

With reference to FIG. 1, there is a block diagram of an example EVPN 100 in which embodiments directed to selective forwarding and fast-convergence for selective multicast traffic with all-active multihoming may be implemented. EVPN 100 includes provider edge nodes (PEs) PE1-PE8 and core routers P1-P3 of an interior or core 102 of the EVPN. A provider edge node (PE) may also be referred to as a “provider edge device.” The PEs and core routers may each include a network device, such as a router or switch, and may be a hardware device, or a virtual device (e.g., a software application or microservice hosted on a server). While only a small number of PEs and core routers are shown, thousands of such network devices may be present in a typical EVPN. The PEs and core routers forward selective multicast traffic (also referred to simply as “multicast traffic”) to each other in/over core 102. The multicast traffic includes data packets and messages, which may be forwarded using network communication protocols, such as, but not limited to, the Transmission Control Protocol/Internet Protocol (TCP/IP), the User Datagram Protocol (UDP), and the like. In the ensuing description, a given provider edge node PEi may be referred to simply as “PEi.”

EVPN 100 includes a multicast source CE4 connected to PE1 (also referred to as a “source PE”). Multicast source CE4 includes a host device or computer that originates multicast traffic toward PE1. The multicast traffic is identified by a tuple (S, G), where “S” denotes a multicast Internet Protocol (IP) source address, and “G” denotes a multicast IP group address. EVPN 100 includes a multicast receiver CE1 that is multihomed to PE7 and PE8 on an ES 104. That is, PE7 and PE8 are peer PEs (sometimes referred simply as “receivers”) that are multihomed to multicast receiver CE1 on ES 104. The peer PEs are configured for all-active multihoming on ES 104. Multicast receiver CE1 includes a host to receive multicast traffic from EVPN 100.

PE1-PE8 and core routers P1-P3 may participate in Border Gateway Protocol (BGP) sessions. Thus, multicast traffic forwarding information (such as BGP routes) may be learned, in part, through message exchanges, e.g., BGP route advertisements between the PEs during the BGP sessions. The multicast traffic forwarding information may also be configured on PE1-PE8, in part, by an administrator. The multicast traffic forwarding information, the BGP sessions, and related messages, such as BGP advertisements, and the like, collectively represent a BGP control plane that generates and disseminates control plane information for use by PE1-PE8. Based on the multicast traffic forwarding information, the PEs of EVPN 100 may forward traffic from one or more multicast sources to one or more multicast receivers.

According to embodiments presented herein, PE1 (the source PE), and PE7 and PE8 (the peer PEs that are multihomed on ES 104), perform respective operations and interact with each other over the ES and core 102 to enable PE1 to (i) selectively forward multicast traffic only to the DF of the peer PEs, and thereby reduce redundant multicast traffic paths in EVPN 100, and (ii) upon detection of an ES failure by the DF, implement fast-convergence (also referred to herein as “fast re-route” (FRR)) for the multicast traffic across the peer PEs. The techniques presented herein extend or modify conventional BGP, as will be described in further detail below.

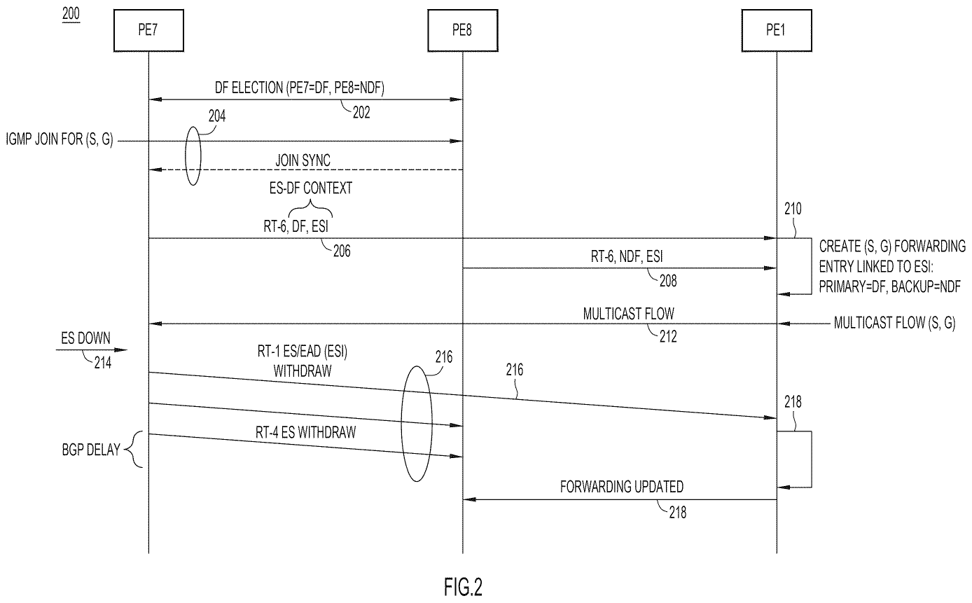

FIG. 2 is a transaction (sequence or call-flow) diagram that shows example transactions 200 performed primarily by PE1 (i.e., the source PE), and PE7 and PE8 (i.e., the peer PEs that are multihomed on ES 104), to implement the selective forwarding and fast-convergence for the multicast traffic with all-active multihoming.

At 202, PE7 and PE8 perform a DF election process that elects PE7 as a DF for ES 104, and designates PE8 as an NDF on the ES. The DF election process may employ any known or hereafter developed DF election process. PE7 and PE8 respectively record their DF states and an ES identifier (ESI) of ES 104. PE7 and PE8 may discover the ESI using any known or hereafter developed ES discovery techniques.

At 204, PE8 receives, from multicast receiver CE1 over ES 104, a multicast join (e.g., an Internet Group Management Protocol (IGMP) join) for/to receive multicast traffic (S, G), and sends to PE7 a join synchronization (sync) to announce the multicast join for the multicast traffic.

Responsive to the join sync, at 206, PE7 advertises to EVPN 100 a first selective multicast route for multicast traffic (S, G). In an example, the first selective multicast route includes an EVPN type 6 selective multicast Ethernet tag (SMET) route (RT-6) (referred to as a “SMET route”) for the multicast traffic (S, G). The SMET route may also be referred to as a “SMET route to/for the last hop PE” (e.g., to PE7). According to the embodiments presented herein, PE7 also provides/sends a first ES-DF context (which is specific to PE7) along with the first SMET route. The first ES-DF context includes or defines (i) a DF state of PE7 that indicates that PE7 is the DF (e.g., has DF state=1) for ES 104, and (ii) an ESI of the ES. The first ES-DF context may be provided in a variety of different ways. For example, the first SMET route may include one or more extended communities (ECs) (each also referred to as an “ext comm”) that carry the ES-DF. For example, a first EC may carry the DF state (which may be flag set to 1 or 0, for example), and a second EC may carry the ESI. The ESI may be represented in the EC as a hash of an actual ESI to reduce the number of bits carried in the EC.

Responsive to the multicast join, at 208, PE8 advertises to EVPN 100 a second selective multicast route for multicast traffic (S, G), and provides a second ES-DF context (specific to PE8) along with the second selective multicast route. In an example, the second selective multicast route includes a second SMET route for multicast traffic (S, G). The second ES-DF context may be carried in one or more ECs of the SMET route. In the example, the second ES-DF context from PE8 includes a DF state that indicates that PE8 is the NDF (e.g., has the DF state=0), and indicates the ESI of ES 104.

Upon receipt of the first SMET route, the first ES-DF context, the second SMET route, and the second ES-DF context, at 210, PE1 creates and stores a forwarding entry for the multicast traffic (S, G) (also referred to simply as the “multicast traffic”). The forwarding entry includes various mappings between information carried in the SMET routes and the ES-DF contexts. The forwarding entry designates PE7 as a primary receiver for the multicast traffic due to the DF state of PE7, and designates PE8 as a backup to the primary receiver for the multicast traffic due to the NDF state of PE8. The forwarding entry also maps or links the ESI of ES 104 (provided in the ES-DFs) to the primary receiver (PE7) and the backup (PE8).

Upon receiving the multicast traffic from multicast source CE4, at 212, PE1 determines which of PE7 and PE8 is the primary receiver/DF for the multicast traffic based on the forwarding entry (e.g., PE1 performs a lookup of the primary receiver in the forwarding based on the tuple (S, G)), and selectively forwards the multicast traffic only to the primary receiver, in this case PE7. In the example, PE1 and PE7 respectively represent a first hop and a last hop for the multicast traffic. PE1 does not forward the multicast traffic to NDF PE8. Thus, PE1 advantageously eliminates a redundant multicast path to NDF PE8 in EVPN 100 that would otherwise be present using conventional multicast forwarding from PE1.

At 214, PE7 senses/detects a failure of ES 104 on a port of PE7 that is connected to multicast receiver CE1. Responsive to detecting the failure, at 216, PE7 sends to both PE8 (the multihomed peer of PE7) and PE1 a withdrawal message that withdraws PE7 as a selective multicast route (e.g., the SMET route) on ES 104. The withdrawal message indicates that PE7 is no longer a viable receiver for the multicast traffic, and also indicates the ESI of ES 104. In an example, the withdrawal message may be a “mass withdrawal” ES/Ethernet auto discovery (EAD) (ES/EAD) route type 1 (RT-1). PE7 also sends to its peer PE (PE8) a route type 4 (RT-4) ES withdraw that initiates a DF election process to elect a new DF (e.g., PE7) on ES 104.

Upon receiving the withdrawal message, at 218, PE1 identifies the backup (NDF PE8) for the multicast traffic based on the forwarding entry. For example, PE1 uses the ESI provided in the withdrawal message to index the backup already mapped/linked to the ESI in the forwarding entry. PE1 switches to selectively forwarding the multicast traffic only to the backup (NDF PE8). Thus, PE1 implements a fast local lookup of the forwarding entry and an immediate FRR from the primary receiver PE7 to the backup PE8 based on the lookup. The FRR suffers only a single BGP delay from the time when PE7 sends the withdrawal message to the time when PE1 switches to selectively forwarding the multicast traffic only to the backup. The FRR avoids additional delays that occur with conventional BGP convergence, in which case PE1 waits for re-advertisement of selective multicast routes from the peer PEs after the withdrawal message and election of the new DF. This is achieved because PE1 initiates a local procedure responsive to the withdrawal message that immediately flips forwarding of the multicast traffic to a new peer PE, without explicitly waiting for control plane convergence.

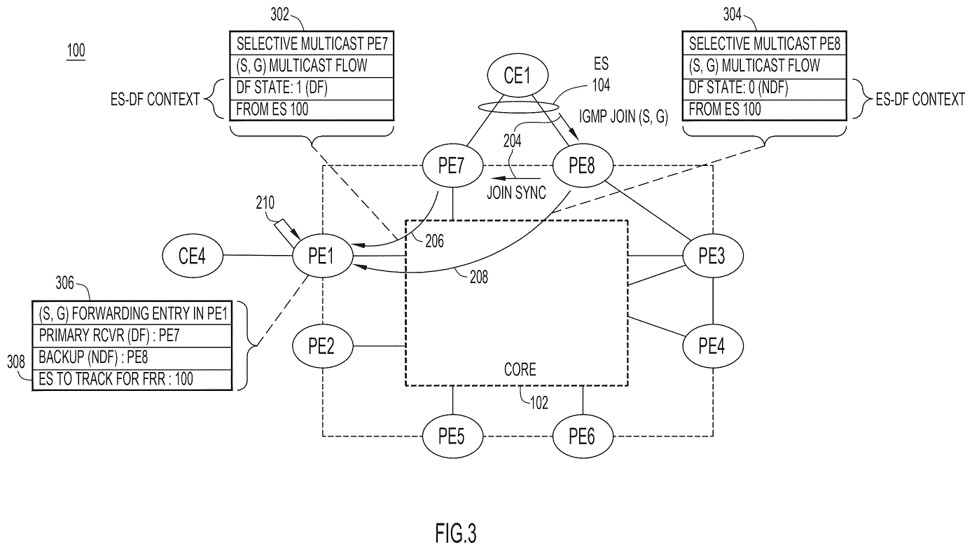

Example messages and data structures associated with transactions 200 of FIG. 2 are described below in connection with FIGS. 3-5. FIGS. 3-5 are described with continued reference to FIG. 2, and also refer to various transactions of FIG. 2.

FIG. 3 shows examples of SMET routes and a forwarding entry generated in connection with initial transactions 204-210 of FIG. 2. Responsive to the join sync and the multicast join at 204, at 206 and 208, PE7 and PE8 respectively advertise a SMET route 302 and a SMET route 304 for the multicast traffic along with ES-DF contexts. SMET route 302 and SMET route 304 are respectively denoted “selective multicast PE7” and “selective multicast PE8” in FIG. 3. As shown, the ES-DF context for SMET route 302 includes a DF state=1 for DF, and an ESI=100 for ES 104. The ES-DF may be included in one or more ECs added to SMET route 302. The ES-DF context for SMET route 304 includes a DF state=0 for NDF, and the ESI=100 for ES 104. The ES-DF for SMET route 304 may be included in one or more ECs added to the SMET route.

Upon receiving SMET routes 302, 304 and their associated ES-DF contexts, at 210, PE1 creates a forwarding entry 306 for the multicast traffic. Forwarding entry 306 designates DF PE7 as the primary receiver for the multicast traffic, and designates NDF PE8 as the backup. Forwarding entry 306 includes an information element (IE) 308 that contains the ESI, which is tracked/used by PE1 for the FRR. Forwarding entry 306 is indexed based on the tuple (S, G) and based on ESI=100 from the ES-DFs, which map or link the tuple (S, G) and the ESI=100 to the primary receiver and the backup for the multicast traffic.

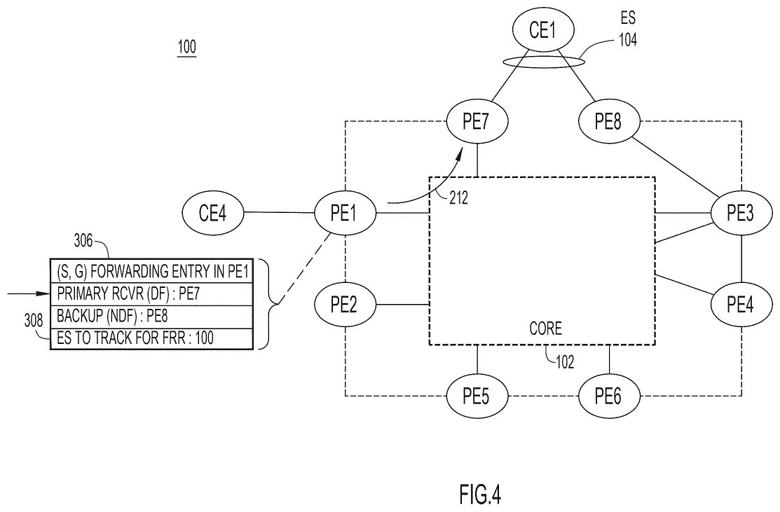

FIG. 4 shows use of forwarding entry 306 by PE1 in connection with transaction 212 of FIG. 2. Upon receiving the multicast traffic from multicast source CE4, at 212, PE1 determines which of peers PE7, PE8 is the primary receiver (i.e., the DF) for the multicast traffic. For example, PE1 performs a lookup of the primary receiver in forwarding entry 306 based on the tuple (S, G). PE1 identifies PE7 as the primary receiver, and selectively forwards the multicast traffic only to PE7, thus eliminating a redundant multicast path to NDF PE8.

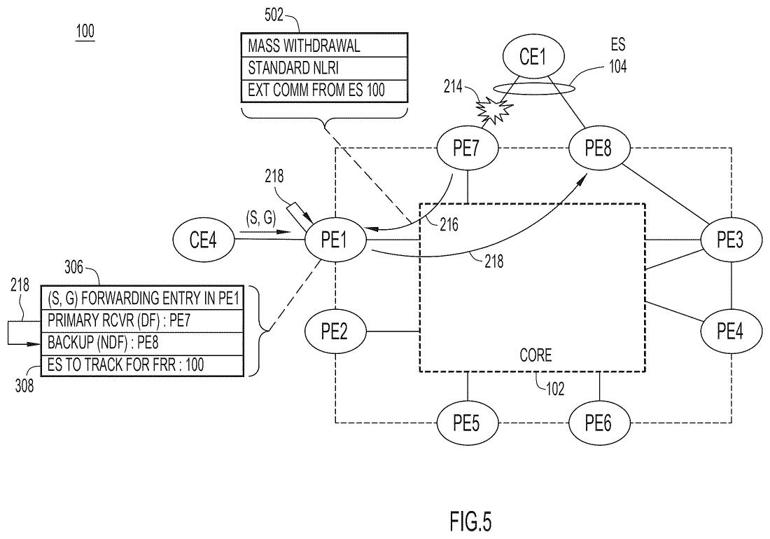

FIG. 5 shows examples of a withdrawal message and use of forwarding entry 306 by PE1 in connection with transactions 216 and 218 of FIG. 2. Upon detecting a failure on ES 104 at 214, at 216, PE7 sends a mass withdrawal 502 to both peer PE8 and PE1. Mass withdrawal 502 includes standard or conventional network layer reachability information (NLRI) and also includes an EC (“ext comm”) that identifies ESI=100 of ES 104. Upon receiving mass withdrawal 502, at 218, PE1 determines the backup to the primary receiver based on forwarding entry 306. For example, PE1 performs a lookup of the backup (PE8) in forwarding entry 306 using ESI=100 from mass withdrawal 502 as an index to match against ESI=100 stored in IE 308 of the forwarding entry. PE1 switches to selectively forwarding the multicast traffic only to the backup (PE8).

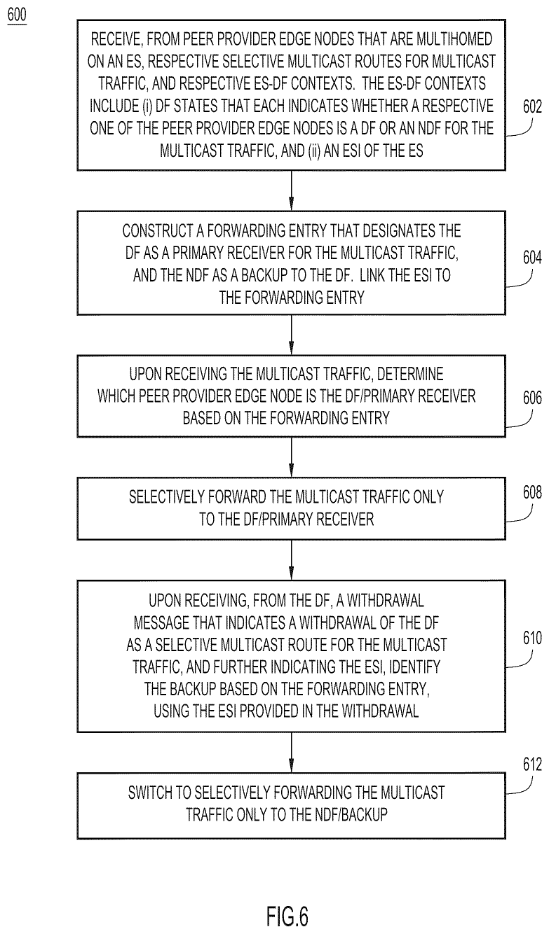

Reference is now made to FIG. 6. FIG. 6 illustrates a flowchart of an example method 600 of selectively forwarding, and implementing a fast-convergence for, multicast traffic that is performed by a provider edge node (e.g., PE1) of an EVPN (e.g., EVPN 100). The provider edge node is configured to communicate with peer provider edge nodes (e.g., PE7 and PE8) of the EVPN that are multihomed to a multicast receiver (e.g., to multicast receiver CE1) on an ES (e.g., ES 104) identified by an ESI. Method 600 includes operations described above.

At 602, the provider edge node receives, from the peer provider edge nodes, respective selective multicast routes (e.g., SMET routes) for multicast traffic, and respective ES-DF contexts. The ES-DF contexts include (i) DF states that each indicates whether a respective one of the peer provider edge nodes that originates the ES-DF is a DF or an NDF for the multicast traffic, and (ii) the ESI of the ES.

At 604, the provider edge node constructs a forwarding entry that designates the DF as a primary receiver for the multicast traffic, and also designates a backup to the DF (among one or more of the peer provider edge nodes that are NDFs) for the multicast traffic. The provider edge node links the ESI to the forwarding entry.

Upon receiving the multicast traffic, at 606, the provider edge node determines which peer provider edge node is the DF/primary receiver for the multicast traffic based on the DF states received from the peer provider edge nodes. The provider edge node performs a lookup of the DF/primary receiver in the forwarding entry using a tuple (S, G) for the multicast traffic.

At 608, the provider edge node selectively forwards the multicast traffic only to the DF/primary receiver.

Upon receiving, from the DF, a withdrawal message that indicates a withdrawal of the DF as a selective multicast route for the multicast traffic, and further indicating the ESI, at 610, the provider edge node identifies the backup based on the DF states received from the peer provider edge nodes. The provider edge node performs a lookup of the backup in the forwarding entry using the ESI provided in the withdrawal message as an index.

At 612, the provider edge node switches to selectively forwarding the multicast traffic only to the backup.

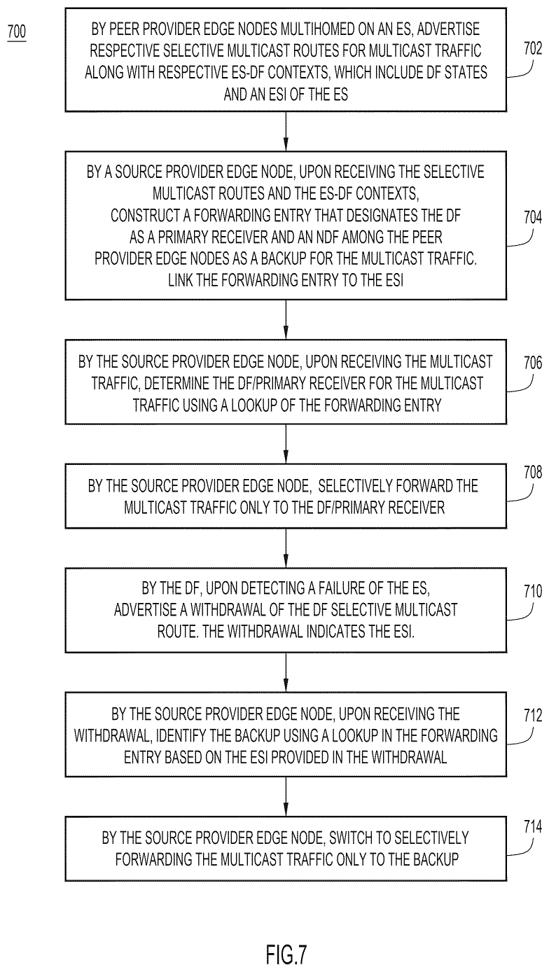

Reference is now made to FIG. 7. FIG. 7 is a flowchart of an example method 700 performed in an EVPN by peer provider edge nodes that are multihomed to a multicast receiver on an ES, and by a source provider edge node of the EVPN, wherein the source provider edge node is connected to a multicast source of multicast traffic. Method 700 includes operations described above.

Specifically, at 702, responsive to join requests, the peer provider edge nodes advertise/send respective selective multicast routes for the multicast traffic along with respective ES-DF contexts. The ES-DF contexts include (i) DF states that each indicates whether a respective one of the peer provider edge nodes that originated the ES-DF context is a DF or is an NDF on the ES, and (ii) an ESI of the ES.

Upon receiving the selective multicast routes and the ES-DF contexts, at 704, the source provider edge node constructs a forwarding entry indexed by a tuple (S, G) for the multicast traffic, and that designates the DF as a primary receiver and one of the NDFs as a backup for the multicast traffic. The source provider edge node links the forwarding entry to the ESI.

Upon receiving the multicast traffic from the multicast source, at 706, the source provider edge node determines the DF/primary receiver for the multicast traffic using a lookup of the forwarding entry based on the tuple (S, G).

At 708, the source provider edge node selectively forwards the multicast traffic only to the DF/primary receiver.

Upon detecting a failure of the ES, at 710, the DF advertises a withdrawal of its selective multicast route. The withdrawal also indicates the ESI.

Upon receiving the withdrawal, at 712, the source provider edge node identifies the backup using a lookup of the backup in the forwarding entry based on the ESI provided in the withdrawal.

At 714, the source provider edge node switches to selectively forwarding the multicast traffic only to the backup.

In summary, the techniques presented herein extend EVPN route operations to create infrastructure that can achieve fast convergence/re-route for multicast similar to unicast (by acting on a mass withdraw). These techniques can communicate a DF state along with a selective multicast route from a multihomed peer. The embodiments associate sufficient context with the selective multicast route so that the remote end (e.g., the source PE) can determine the Ethernet segment to which the join, which triggered advertising the selective multicast routes, belongs. The embodiments provide a local procedure at the source PE to act on mass withdrawal so that traffic can be flipped to a new DF without explicitly waiting for control plane convergence.

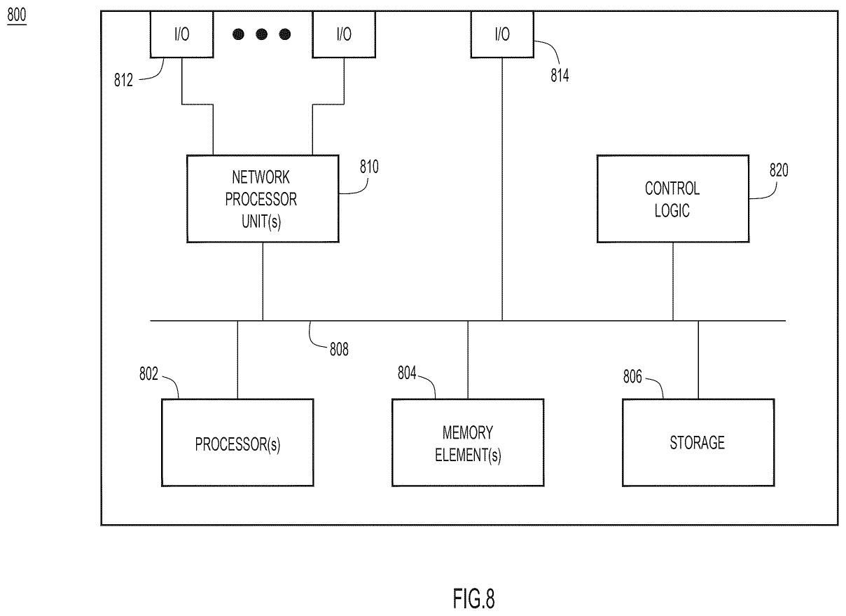

Referring to FIG. 8, FIG. 8 illustrates a hardware block diagram of a computing device 800 that may perform functions associated with operations discussed herein in connection with the techniques depicted in FIGS. 1-7. In various embodiments, a computing device or apparatus, such as computing device 800 or any combination of computing devices 800, may be configured as any entity/entities as discussed for the techniques depicted in connection with FIGS. 1-7 in order to perform operations of the various techniques discussed herein. Computing device 800 may represent any of a provider edge node, a core router, a multicast source, and a multicast receiver, for example.

In at least one embodiment, the computing device 800 may be any apparatus that may include one or more processor(s) 802, one or more memory element(s) 804, storage 806, a bus 808, one or more network processor unit(s) 810 interconnected with (e.g., coupled to) one or more network input/output (I/O) interface(s) 812, one or more I/O interface(s) 814, and control logic 820. In various embodiments, instructions associated with logic for computing device 800 can overlap in any manner and are not limited to the specific allocation of instructions and/or operations described herein.

In at least one embodiment, processor(s) 802 is/are at least one hardware processor configured to execute various tasks, operations and/or functions for computing device 800 as described herein according to software and/or instructions configured for computing device 800. Processor(s) 802 (e.g., a hardware processor) can execute any type of instructions associated with data to achieve the operations detailed herein. In one example, processor(s) 802 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 804 and/or storage 806 is/are configured to store data, information, software, and/or instructions associated with computing device 800, and/or logic configured for memory element(s) 804 and/or storage 806. For example, any logic described herein (e.g., control logic 820) can, in various embodiments, be stored for computing device 800 using any combination of memory element(s) 804 and/or storage 806. Note that in some embodiments, storage 806 can be consolidated with memory element(s) 804 (or vice versa), or can overlap/exist in any other suitable manner.

In at least one embodiment, bus 808 can be configured as an interface that enables one or more elements of computing device 800 to communicate in order to exchange information and/or data. Bus 808 can be implemented with any architecture designed for passing control, data and/or information between processors, memory elements/storage, peripheral devices, and/or any other hardware and/or software components that may be configured for computing device 800. In at least one embodiment, bus 808 may be implemented as a fast kernel-hosted interconnect, potentially using shared memory between processes (e.g., logic), which can enable efficient communication paths between the processes.

In various embodiments, network processor unit(s) 810 may enable communication between computing device 800 and other systems, entities, etc., via network I/O interface(s) 812 (wired and/or wireless) to facilitate operations discussed for various embodiments described herein. In various embodiments, network processor unit(s) 810 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 800 and other systems, entities, etc. to facilitate operations for various embodiments described herein. In various embodiments, network I/O interface(s) 812 can be configured as one or more Ethernet port(s), Fibre Channel ports, any other I/O port(s), and/or antenna(s)/antenna array(s) now known or hereafter developed. Thus, the network processor unit(s) 810 and/or network I/O interface(s) 812 may include suitable interfaces for receiving, transmitting, and/or otherwise communicating data and/or information in a network environment.

I/O interface(s) 814 allow for input and output of data and/or information with other entities that may be connected to computing device 800. For example, I/O interface(s) 814 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 820 can include instructions that, when executed, cause processor(s) 802 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 820) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 804 and/or storage 806 can store data, software, code, instructions (e.g., processor instructions), logic, parameters, combinations thereof, and/or the like used for operations described herein. This includes memory element(s) 804 and/or storage 806 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi 6®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4(IPv4 ) and/or IP version 6(IPv6 ) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’nomenclature (e.g., one or more element(s)).

In summary, in some aspects, the techniques described herein relate to a method performed by a provider edge node of an Ethernet virtual private network (EVPN) in which the provider edge node is configured to communicate with peer provider edge nodes of the EVPN that are multihomed to a multicast receiver, including: receiving, from the peer provider edge nodes, selective multicast routes for multicast traffic, and designated forwarder states that each indicates whether a respective one of the peer provider edge nodes is a designated forwarder or a non-designated forwarder for the multicast traffic; upon receiving the multicast traffic, determining which of the peer provider edge nodes is the designated forwarder for the multicast traffic based on the designated forwarder states received from the peer provider edge nodes; and selectively forwarding the multicast traffic only to the designated forwarder.

In some aspects, the techniques described herein relate to a method, further including: storing a forwarding entry that associates the peer provider edge nodes to the designated forwarder states; wherein determining includes performing a lookup of the designated forwarder in the forwarding entry.

In some aspects, the techniques described herein relate to a method, wherein: each selective multicast route includes a selective multicast Ethernet tag (SMET) route with an extended community that includes a designated forwarder state.

In some aspects, the techniques described herein relate to a method, further including: upon receiving, from the designated forwarder, a withdrawal message that indicates a withdrawal of the designated forwarder as a selective multicast route for the multicast traffic, identifying a backup to the designated forwarder among one or more of the peer provider edge nodes that are non-designated forwarders, based on the designated forwarder states received from the peer provider edge nodes; and switching to selectively forwarding the multicast traffic only to the backup.

In some aspects, the techniques described herein relate to a method, further including: storing a forwarding entry that associates the peer provider edge nodes to respective ones of the designated forwarder states; wherein determining includes performing a lookup of the backup in the forwarding entry.

In some aspects, the techniques described herein relate to a method, further including: receiving, from each peer provider edge node, an Ethernet segment identifier (ESI) on which the peer provider edge nodes are multihomed; and wherein receiving the withdrawal message includes receiving the withdrawal message to include the ESI; wherein identifying the backup further includes matching the ESI in the withdrawal message to the ESI received from each peer provider edge node.

In some aspects, the techniques described herein relate to a method, wherein: each selective multicast route includes a selective multicast Ethernet tag (SMET) route with an extended community that includes the ESI.

In some aspects, the techniques described herein relate to a method, further including: creating a forwarding entry that associates the peer provider edge nodes to respective ones of the designated forwarder states and to the ESI.

In some aspects, the techniques described herein relate to an apparatus including: a network interface unit to communicate with peer provider edge nodes of an Ethernet virtual private network (EVPN) in which the peer provider edge nodes are multihomed to a multicast receiver; and a processor of a provider edge node of the EVPN, wherein the processor is coupled to the network interface unit and is configured to perform: receiving, from the peer provider edge nodes, selective multicast routes for multicast traffic, and designated forwarder states that each indicates whether a respective one of the peer provider edge nodes is a designated forwarder or a non-designated forwarder for the multicast traffic; upon receiving the multicast traffic, determining which of the peer provider edge nodes is the designated forwarder for the multicast traffic based on the designated forwarder states received from the peer provider edge nodes; and selectively forwarding the multicast traffic only to the designated forwarder.

In some aspects, the techniques described herein relate to an apparatus, wherein the processor is further configured to perform: storing a forwarding entry that associates the peer provider edge nodes to the designated forwarder states; wherein the processor is configured to perform determining by performing a lookup of the designated forwarder in the forwarding entry.

In some aspects, the techniques described herein relate to an apparatus, wherein: each selective multicast route includes a selective multicast Ethernet tag (SMET) route with an extended community that includes a designated forwarder state.

In some aspects, the techniques described herein relate to an apparatus, wherein the processor is further configured to perform: upon receiving, from the designated forwarder, a withdrawal message that indicates a withdrawal of the designated forwarder as a selective multicast route for the multicast traffic, identifying a backup to the designated forwarder among one or more of the peer provider edge nodes that are non-designated forwarders, based on the designated forwarder states received from the peer provider edge nodes; and switching to selectively forwarding the multicast traffic only to the backup.

In some aspects, the techniques described herein relate to an apparatus, wherein the processor is further configured to perform: storing a forwarding entry that associates the peer provider edge nodes to respective ones of the designated forwarder states; wherein the processor is configured to perform determining by performing a lookup of the backup in the forwarding entry.

In some aspects, the techniques described herein relate to an apparatus, wherein the processor is further configured to perform: receiving, from each peer provider edge node, an Ethernet segment identifier (ESI) on which the peer provider edge nodes are multihomed; and wherein the processor is configured to perform receiving the withdrawal message by receiving the withdrawal message to include the ESI; wherein the processor is configured to perform identifying the backup by matching the ESI in the withdrawal message to the ESI received from each peer provider edge node.

In some aspects, the techniques described herein relate to an apparatus, wherein: each selective multicast route includes a selective multicast Ethernet tag (SMET) route with an extended community that includes the ESI.

In some aspects, the techniques described herein relate to a method including: by peer provider edge nodes of an Ethernet virtual private network (EVPN) that are multihomed to a multicast receiver, advertising selective multicast routes for multicast traffic, and designated forwarder states that each indicates whether a respective one of the peer provider edge nodes is a designated forwarder or is a non-designated forwarder for the multicast traffic; and by a source provider edge node of the EVPN: receiving the selective multicast routes and the designated forwarder states from the peer provider edge nodes; upon receiving the multicast traffic from a multicast source, determining the designated forwarder of the peer provider edge nodes for the multicast traffic based on the designated forwarder states received from the peer provider edge nodes; and selectively forwarding the multicast traffic only to the designated forwarder.

In some aspects, the techniques described herein relate to a method, wherein: each selective multicast route includes a selective multicast Ethernet tag (SMET) route with an extended community that includes a designated forwarder state.

In some aspects, the techniques described herein relate to a method, further including: by the source provider edge node, upon receiving, from the designated forwarder, a withdrawal message that indicates a withdrawal of the designated forwarder as a selective multicast route for the multicast traffic, identifying a backup for the designated forwarder among one or more of the peer provider edge nodes that are non-designated forwarders, based on the designated forwarder states received from the peer provider edge nodes; and switching to selectively forwarding the multicast traffic only to the backup.

In some aspects, the techniques described herein relate to a method, further including: by the peer provider edge nodes, respectively sending an Ethernet segment identifier (ESI) on which the peer provider edge nodes are multihomed; and wherein the withdrawal message includes the ESI; wherein identifying the backup further includes matching the ESI in the withdrawal message to the ESI received from the peer provider edge nodes.

In some aspects, the techniques described herein relate to a method, wherein: each selective multicast route includes a selective multicast Ethernet tag (SMET) route with an extended community that includes the ESI.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method performed by a provider edge node of an Ethernet virtual private network (EVPN) in which the provider edge node is configured to communicate with peer provider edge nodes of the EVPN that are multihomed to a multicast receiver, comprising:
receiving, from the peer provider edge nodes, selective multicast routes for multicast traffic, and designated forwarder states that each indicates whether a respective one of the peer provider edge nodes is a designated forwarder or a non-designated forwarder for the multicast traffic;
upon receiving the multicast traffic, determining which of the peer provider edge nodes is the designated forwarder for the multicast traffic based on the designated forwarder states received from the peer provider edge nodes; and
selectively forwarding the multicast traffic only to the designated forwarder.

2. The method of claim 1, further comprising:
storing a forwarding entry that associates the peer provider edge nodes to the designated forwarder states;
wherein determining includes performing a lookup of the designated forwarder in the forwarding entry.

3. The method of claim 1, wherein:
each selective multicast route includes a selective multicast Ethernet tag (SMET) route with an extended community that includes a designated forwarder state.

4. The method of claim 1, further comprising:
upon receiving, from the designated forwarder, a withdrawal message that indicates a withdrawal of the designated forwarder as a selective multicast route for the multicast traffic, identifying a backup to the designated forwarder among one or more of the peer provider edge nodes that are non-designated forwarders, based on the designated forwarder states received from the peer provider edge nodes; and
switching to selectively forwarding the multicast traffic only to the backup.

5. The method of claim 4, further comprising:
storing a forwarding entry that associates the peer provider edge nodes to respective ones of the designated forwarder states;
wherein determining includes performing a lookup of the backup in the forwarding entry.

6. The method of claim 4, further comprising:
receiving, from each peer provider edge node, an Ethernet segment identifier (ESI) on which the peer provider edge nodes are multihomed; and
wherein receiving the withdrawal message includes receiving the withdrawal message to include the ESI;
wherein identifying the backup further includes matching the ESI in the withdrawal message to the ESI received from each peer provider edge node.

7. The method of claim 6, wherein:
each selective multicast route includes a selective multicast Ethernet tag (SMET) route with an extended community that includes the ESI.

8. The method of claim 6, further comprising:
creating a forwarding entry that associates the peer provider edge nodes to respective ones of the designated forwarder states and to the ESI.

9. An apparatus comprising:
a network interface unit to communicate with peer provider edge nodes of an Ethernet virtual private network (EVPN) in which the peer provider edge nodes are multihomed to a multicast receiver; and
a processor of a provider edge node of the EVPN, wherein the processor is coupled to the network interface unit and is configured to perform:
receiving, from the peer provider edge nodes, selective multicast routes for multicast traffic, and designated forwarder states that each indicates whether a respective one of the peer provider edge nodes is a designated forwarder or a non-designated forwarder for the multicast traffic;
upon receiving the multicast traffic, determining which of the peer provider edge nodes is the designated forwarder for the multicast traffic based on the designated forwarder states received from the peer provider edge nodes; and
selectively forwarding the multicast traffic only to the designated forwarder.

10. The apparatus of claim 9, wherein the processor is further configured to perform:
storing a forwarding entry that associates the peer provider edge nodes to the designated forwarder states;
wherein the processor is configured to perform determining by performing a lookup of the designated forwarder in the forwarding entry.

11. The apparatus of claim 9, wherein:
each selective multicast route includes a selective multicast Ethernet tag (SMET) route with an extended community that includes a designated forwarder state.

12. The apparatus of claim 9, wherein the processor is further configured to perform:
upon receiving, from the designated forwarder, a withdrawal message that indicates a withdrawal of the designated forwarder as a selective multicast route for the multicast traffic, identifying a backup to the designated forwarder among one or more of the peer provider edge nodes that are non-designated forwarders, based on the designated forwarder states received from the peer provider edge nodes; and
switching to selectively forwarding the multicast traffic only to the backup.

13. The apparatus of claim 12, wherein the processor is further configured to perform:
storing a forwarding entry that associates the peer provider edge nodes to respective ones of the designated forwarder states;
wherein the processor is configured to perform determining by performing a lookup of the backup in the forwarding entry.

14. The apparatus of claim 12, wherein the processor is further configured to perform:
receiving, from each peer provider edge node, an Ethernet segment identifier (ESI) on which the peer provider edge nodes are multihomed; and
wherein the processor is configured to perform receiving the withdrawal message by receiving the withdrawal message to include the ESI;
wherein the processor is configured to perform identifying the backup by matching the ESI in the withdrawal message to the ESI received from each peer provider edge node.

15. The apparatus of claim 14, wherein:
each selective multicast route includes a selective multicast Ethernet tag (SMET) route with an extended community that includes the ESI.

16. A method comprising:
by peer provider edge nodes of an Ethernet virtual private network (EVPN) that are multihomed to a multicast receiver, advertising selective multicast routes for multicast traffic, and designated forwarder states that each indicates whether a respective one of the peer provider edge nodes is a designated forwarder or is a non-designated forwarder for the multicast traffic; and
by a source provider edge node of the EVPN:
receiving the selective multicast routes and the designated forwarder states from the peer provider edge nodes;
upon receiving the multicast traffic from a multicast source, determining the designated forwarder of the peer provider edge nodes for the multicast traffic based on the designated forwarder states received from the peer provider edge nodes; and
selectively forwarding the multicast traffic only to the designated forwarder.

17. The method of claim 16, wherein:
each selective multicast route includes a selective multicast Ethernet tag (SMET) route with an extended community that includes a designated forwarder state.

18. The method of claim 16, further comprising:
by the source provider edge node, upon receiving, from the designated forwarder, a withdrawal message that indicates a withdrawal of the designated forwarder as a selective multicast route for the multicast traffic, identifying a backup for the designated forwarder among one or more of the peer provider edge nodes that are non-designated forwarders, based on the designated forwarder states received from the peer provider edge nodes; and
switching to selectively forwarding the multicast traffic only to the backup.

19. The method of claim 18, further comprising:
by the peer provider edge nodes, respectively sending an Ethernet segment identifier (ESI) on which the peer provider edge nodes are multihomed; and
wherein the withdrawal message includes the ESI;
wherein identifying the backup further includes matching the ESI in the withdrawal message to the ESI received from the peer provider edge nodes.

20. The method of claim 19, wherein:
each selective multicast route includes a selective multicast Ethernet tag (SMET) route with an extended community that includes the ESI.
